(19) United States
(12) Patent Application Publication
(10) Pub. No.: US 2011/0101714 A1
(43) Pub. Date: May 5, 2011

(54) Bumper energy absorber and method of fabricaitng and assembling the same

(76) Inventor: Mary, Ann Bator, Farmington Hills, MI (US)

(21) Appl. No.: 10/556,668

(22) PCT Filed: Jun. 2, 2004
(86) PCT No.: PCT/CA04/00823

§ 371 Date: Nov. 15, 2006

(30) Foreign Application Priority Data
Jun. 3, 2003 (US) 60475275

(51) Int. Cl. B60R 19/26; B23P 11/00

(52) U.S. Cl. 293/132; 29/428

(57) ABSTRACT

A bumper beam energy absorbing system (10) is disclosed for absorbing impact energy exerted on an automotive vehicle. The energy absorbing system (10) includes a rigid, structural impact beam (12), a decorative fascia (16), and an energy absorber (14) sandwiched between the impact beam (12) and fascia (16). The impact beam (12) is adapted to attach the energy absorber to the vehicle while the fascia (16) decoratively covers and conceals the energy absorber (14). The energy absorber (14) is comprised of layers of cell panels (20). Each cell panel (20) is extruded into an open cell network in which interconnected closed loop cell walls define a plurality of open cells, thereby creating the network. The cross-section of the cells (22, 22′) in one cell panel may differ to adjust the amount of energy absorbed by a particular section of the panel. Likewise, the overall open cell network may vary between the layers, thereby adjusting the amount of energy absorbed by each particular layer.

### FIELD OF THE INVENTION

This invention relates to a motor vehicle bumper assembly. More particularly, this invention relates to a motor vehicle bumper beam energy absorber that is constructed of extruded plastic in a cell network, and a method of fabricating and assembling the same.

### DESCRIPTION OF THE PRIOR ART

Bumpers are used on automobiles for absorbing shock and impact from collisions, thereby preventing and/or decreasing injury to persons and damage to property, including the vehicle. Automobile bumpers typically include an impact or reinforcement beam, energy absorbers surrounding the beam, and a fascia surrounding the energy absorber. The beam, usually constructed of high strength steel or aluminum, is attached to the vehicle frame. The energy absorber is typically a foam material although hydraulic or gas piston and cylinder assemblies have been used. The third main component, the fascia, is the visible exterior of the bumper assembly, and is typically made of plastic. Of the three main bumper system components, the one most relevant to the present invention is the energy absorber.

The energy absorber of the bumper absorbs energy during a collision, thereby helping to prevent damage to the motor vehicle. Since the mass of cars and trucks varies, the amount of energy that needs to be absorbed to prevent damage also varies. Accordingly, different vehicles require different shaped and sized bumper systems. However, many of the current bumper systems require expensive molds to manufacture the commonly used injection molded bumper beam energy absorbers. Due to the high cost of these molds, energy absorbers are not specifically designed for each specific type of vehicle. Instead, a one-size-fits-all-type energy absorber is used on many different vehicles, often adding excess weight to the vehicle and excess cost due to the use of unnecessary materials.

Therefore, it would be beneficial to have in energy absorber that can be specifically designed for optimal performance in different size/weight vehicles without the need for the costly molds needed by other types of energy absorbers. Designing an energy absorber for each specific vehicle will reduce the excess weight and material cost due to energy absorber overdesign. Furthermore, the expensive injection molds will no longer be needed.

### SUMMARY OF THE INVENTION

According to one aspect of the invention, there is provided a bumper beam energy absorber for use with an automotive vehicle. A rigid structural impact beam attaches the bumper beam energy absorber to the vehicle. A decorative fascia is spaced from the impact beam. The energy absorber is sandwiched between the impact beam and the fascia. The energy absorber includes at least one layer of cell panels, which are formed by interconnected closed loop cells, to define an open cell network for absorbing impact energy exerted upon the fascia before the energy reaches the impact beam.

The energy absorber may have a plurality of layers of cell panels. The open cell network may vary between cell panel layers in the energy absorber. The overall size, degree of elongation, and cell length may vary between cell panel layers to adjust the amount of energy absorbed by each particular cell panel layer. Further, the cross-section of the cells in one cell panel layer may vary to adjust the amount of energy that can be absorbed by a particular section of the cell panel layer.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a cross-sectional view taken along line A-A in FIG. 2 of an energy absorbing bumper system;

FIG. 2 is a perspective view of an energy absorbing bumper system;

FIG. 3 is a fragmentary perspective view of the energy absorbing bumper system;

FIG. 4 is an expanded perspective view of an energy absorber and an impact beam;

FIG. 5 is an enlarged view of section A in FIG. 4 of an energy absorber; and

FIG. 6 is a cross-sectional view taken along line A-A in FIG. 2 of an energy absorber with reinforcing material.

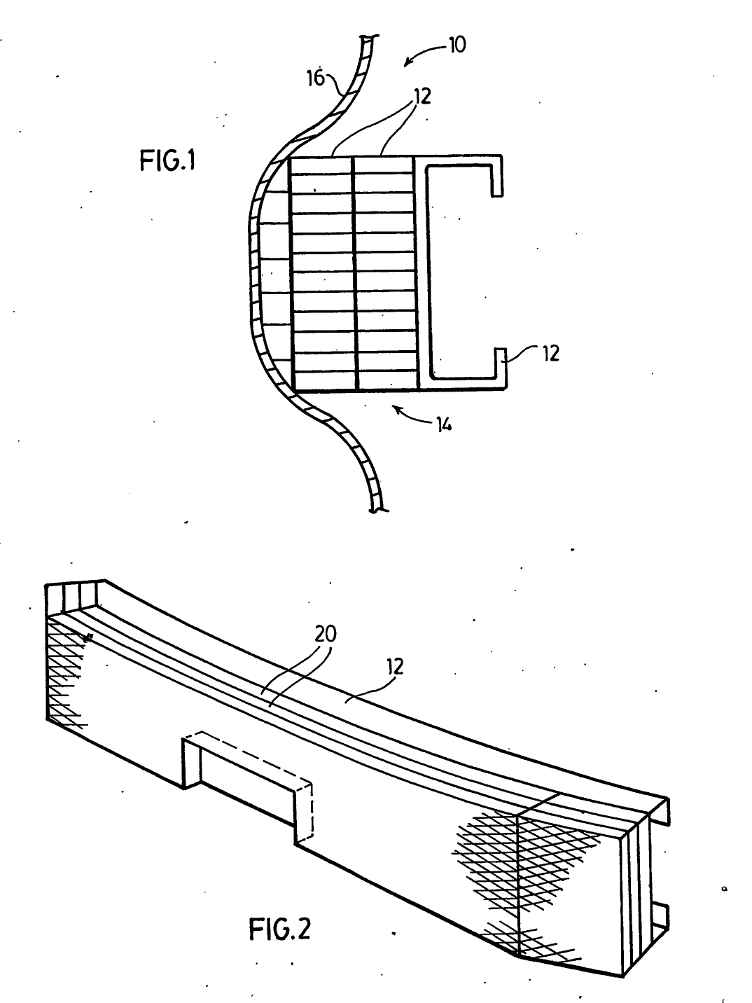

### DETAILED DESCRIPTION OF THE PREFERRED EMBODIMENT

Referring to the Figures, an energy absorbing bumper system is generally indicated at 10. The energy absorbing bumper system 10 includes an impact beam 12, an energy absorber 14, and a fascia 16. The energy absorber 14 includes layers of extruded cell panels 20.

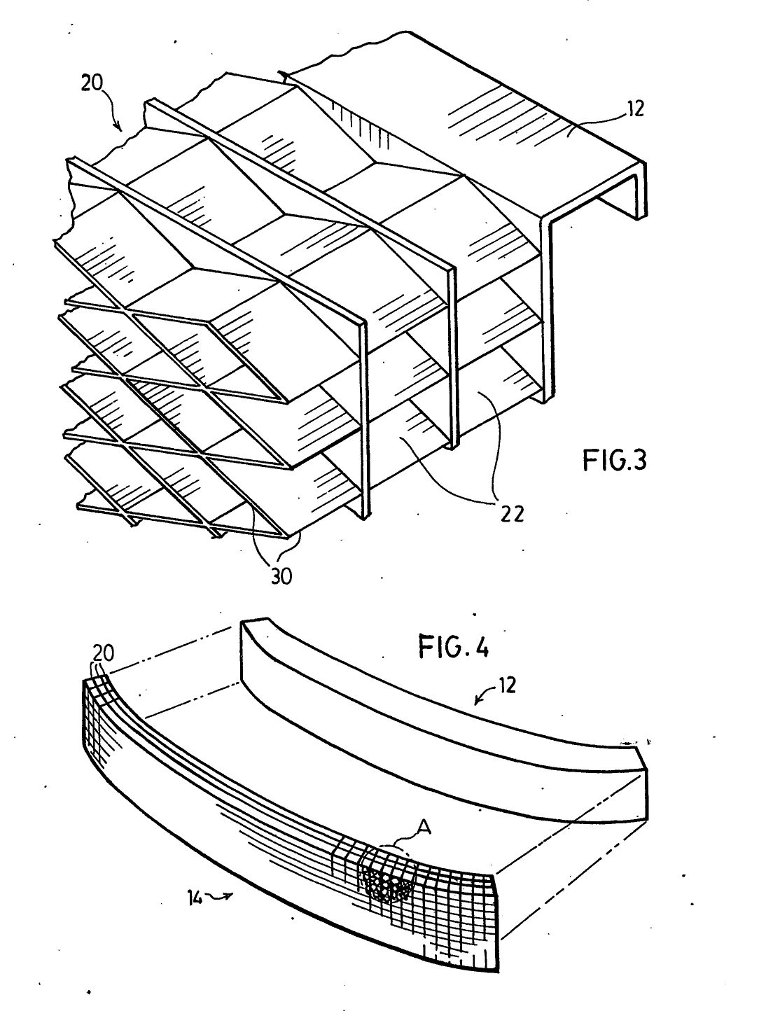

The cell panels 20 may be of any extrudable material, preferably a low-cost olefinic material. The extrusion process eliminates the need for expensive molds required to manufacture injection molded bumper beam energy absorbers in order to accommodate different vehicles. Additionally, the extruded part is lighter than foamed energy absorbers and capable of absorbing more energy. Each cell panel 20 is made up from a plurality of joined hollow cells 22 and 22′ formed during the extrusion process, which results in an open-cell network. The cells 22, 22′ can be of any shape such as honeycomb, diamond or oval in shape, as shown in FIGS. 3 and 4 and may have any geometric cross-sectional shapes. The extrusion process can be continuous and the extruded material then hot wire cut to the desired width on a continuous basis.

Each cell 22 is formed or defined by a continuous or closed loop cell wall 30 to create the open-cell network. The configuration of cells 22, with respect to size and direction, can be varied along the length and thickness of the energy absorber 14 to optimize the shock absorption due to different types of impact across the bumper beam, since the impact energy is different when the vehicle is hit straight on, from the side, etc. More specifically, the extrusion process allows for the size of the cells 22 and the thickness of the cell wall 30 in any section of the extrusion to be varied within a cell panel 20. Thus, the amount of energy that can be absorbed by the energy absorber 14 in one section of the bumper system 10 is greater than the other section. Likewise, the overall size, degree of elongation, and the direction of the length L of the cells 22 can be varied between the layers of cell panels 20 to change the overall amount of energy that can be absorbed by the energy absorber 14.

Further, one or more layers of cell panels 20 may be stacked. Each layer of cell panels 20 may have a different length L and/or a plurality of arrays of different sized cells 22 and cell wall 30 thickness. The positioning of the sections of the cell panels 20 in each layer is configured to cooperate with sections of adjacent layers to absorb energy.

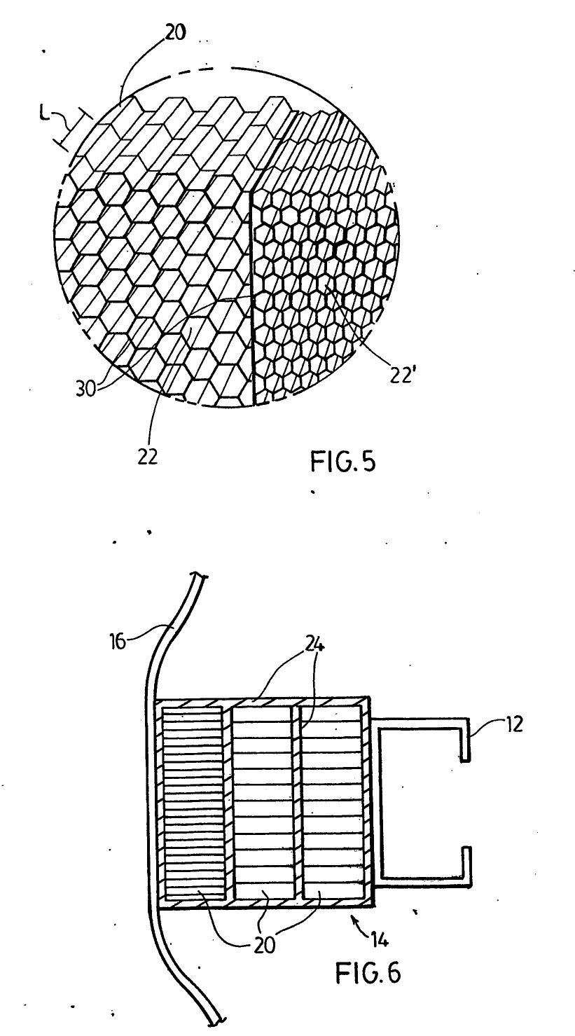

Referring to FIG. 6, the layers of cell panels 20 may include a reinforcing sheet material 24 placed in-between adjacent stacked layers of cell panels 20 shown in FIGS. 2 and 6, or covering the outermost layers of cell panels 20, or completely encapsulating the energy absorber 14. The reinforcing material 24 can be of any sheet material which tends to strengthen, including woven, non-woven, plastic, glass, paper, any organic fibers such as cotton or flax, or metal foil material.

One skilled in the art will recognize that there are numerous combinations of the above components. As a result, the properties of the cells 22 and the number of layers of cell panels 20 can be modified to absorb the amount of energy necessary for a specific vehicle. Addition of a reinforcing material 24 will increase the strength of the energy absorber 14. Designing the energy absorber 14 for each specific vehicle will eliminate unnecessary weight to the vehicle due to overdesign.

In another embodiment of the energy absorber 14, protection for pedestrian impact is incorporated into the design. The cells 22 and the layers of cell panels 20 are designed such that the cell panel 20 constituting the outermost layer, closest to the fascia 16 and closest to the pedestrian, collapses more readily than subsequent layers, thereby reducing the severity of impact to a pedestrian.

The method of fabricating and assembling a bumper beam energy absorber 14 begins with extruding a provided sheet material into an open-cell network, thereby forming a cell panel 20. The extrusion process may be done on a continuous basis and then cut, via a method such as hot wire cutting, to the desired width.

The next step is to integrate, stack, or overlap the necessary or desired number of layers of cell panels 20, thereby forming the energy absorber 14. The energy absorber 14 is conformed to the shape of the inner face of the fascia 16 enabling the energy absorber 14 to nest within the fascia 16. The conforming step can take place as the energy absorber 14 is being assembled, or when the cell panel 20 is still warm from the extrusion process.

The final step is to install the energy absorber 14 between a provided structural impact beam 12 and a provided decorative fascia 16. The installation can be via a variety of methods, including the use of fasteners, adhesive, heat staking, or sonic welding.

The invention has been described in an illustrative manner, and it is to be understood that the terminology that has been used is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A bumper beam energy absorber for use with an automotive vehicle comprising at least one layer of cell panels having interconnected closed loop cells defining an open cell network, said open cell network comprising at least two different sized cells positioned in at least two sections to absorb more energy in one section than another.

2. A bumper beam energy absorber as set forth in claim 1, wherein said energy absorber includes at least two layers of said cell panels.

3. A bumper beam energy absorber as set forth in claim 2 wherein each of said open cell networks of each of said layers has at least two different sized cells positioned in at least two sections to absorb relatively more energy in one section than another.

4. A bumper beam energy absorber as set forth in claim 3 wherein said positioning of said sections of said layers of cell panels cooperate to absorb energy.

5. A bumper beam energy absorber as set forth in claim 4 wherein a reinforcing sheet material is interposed between said layers of cell panels.

6. A bumper beam energy absorber as set forth in claim 4 wherein said layers of cell panels are enclosed with a reinforcing sheet material.

7. A bumper beam energy absorber as set forth in claim 1 wherein each of said cell panels are extruded.

8. A bumper beam energy absorber as set forth in claim 7 wherein said extruded cell panels has said at least two sections wherein a first of said two sections has cells of a first predetermined size and wall thickness and a second of said two sections has cells of a second predetermined size and wall thickness, less than said first predetermined size and wall thickness.

9. A vehicle bumper system comprising
an impact beam configured to be attached to a vehicle frame,
a fascia positioned to conceal said impact beam, and
an energy absorber sandwiched between said impact beam and said fascia, said energy absorber comprising at least one layer of cell panels having interconnected closed loop cells defining an open cell network, said open cell network comprising at least two different sized cells positioned in at least two sections to absorb more energy in one section than another.

10. A vehicle bumper system as set forth in claim 7 wherein said energy absorber is contoured to nest within and support said fascia.

11. A vehicle bumper system as set forth in claim 10 wherein each of said cell panels are extruded.

12. A vehicle bumper system as set forth in claim 11 wherein said extruded cell panels has said at least two sections wherein a first of said two sections has cells of a first predetermined size and wall thickness and a second of said two sections has cells of a second predetermined size and wall thickness, less than said first predetermined size and wall thickness.

13. A vehicle bumper system as set forth in claim 12, wherein said energy absorber includes at least two layers of said cell panels.

14. A vehicle bumper system as set forth in claim 13 wherein each of said open cell networks of each of said layers has at least two different sized cells positioned in the at least two sections to absorb relatively more energy in one section than another.

15. A vehicle bumper system as set forth in claim 14 wherein a reinforcing sheet material is interposed between said layers of cell panels.

16. A vehicle bumper system as set forth in claim 14 wherein said layers of cell panels are enclosed with a reinforcing sheet material.

17. A vehicle bumper system as set forth in claim 14 wherein an outermost layer of cell panels is configured to collapse more readily than an inner layer of cell panels.

18. A vehicle bumper system as set forth in claim 17 wherein said outermost layer is adjacent said fascia.

19. A method of manufacturing a vehicle bumper system, said method comprising the steps of:
extruding a sheet material into a cell panel having an open cell network comprising at least two different sized cells positioned in at least two sections to absorb more energy in one section than another;
combining at least two cell panels to form an energy absorber;
conforming an outer face of said energy absorber to complementarily fit within an inner face of a fascia;
combining said energy absorber between said fascia and an impact beam.
